(19) United States
(12) Patent Application Publication
(10) Pub. No.: US 2004/0114099 A1
(43) Pub. Date: Jun. 17, 2004

(54) Eyeglasses frame and method for assembling/manufacturing same, structure for fixing eyeglasses lenses

(76) Inventors: Takeji Shiokawa, Hadano (JP); Mitsuya Mikawa, Hadano (JP); Toshiaki Ichinose, Hadano (JP); Yasuhisa Sunai, Hadano (JP); Masafumi Kamura, Chofu (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/467,158

(22) PCT Filed: Sep. 5, 2001
(86) PCT No.: PCT/JP01/07702

(30) Foreign Application Priority Data
Feb. 13, 2001 (JP) 2001-034778

(51) Int. Cl. G02C 5/14; G02C 5/00

(52) U.S. Cl. 351/121

(57) ABSTRACT

In an eyeglasses to which the invention is applied, a taper nut having a collar portion and a conical taper portion is fitted and attached to a hole having a circular truncated cone shape and pierced in an eyeglasses part. A hole for passing a male screw therethrough is formed in another eyeglasses part, and the eyeglasses parts are connected to each other by screwing the male screw inserted to the hole with a female screw provided in an inner portion of the taper nut. Further, continuous holes having a circular truncated cone shape are pierced in both the connected eyeglasses parts. It is possible to prevent both the eyeglasses parts from rotating with each other by fitting the taper nut to the hole, and both the parts are connected by engaging the male screw from a side in which the taper of the taper nut is reduced.

### TECHNICAL FIELD

The present invention relates to frames of an eyeglasses, a method of assembling the eyeglasses and a structure of the frames into which lenses are set, and in particular relates to a mounting portion of eyeglasses frame parts such as an end piece, a bridge or the like, a connection portion among a closing block, a skull temple and the end piece, and a connection structure between the eyeglasses parts in eyeglasses lens of a rimless eyeglasses and eyeglasses frame parts.

### BACKGROUND OF THE INVENTION

A general lens mounting structure of eyeglasses is structured, as shown in FIGS. 24 and 25, such that a lens 4 is connected to an end piece 5 by passing a male screw 7 to a through hole 41 pierced in the lens 4 by a drill or the like and a through hole 50 pierces in the end piece 5 by a drill or the like from a front face side of the lens 4, and screwing the male screw 7 protruding to a back face side of the lens 4 by a nut 8.

In the lens mounting structure of the eyeglasses described in JP-A-2000-105356, the lens and the end piece are connected by fitting an inserting and fitting columnar body formed integrally with the end piece, having a female screw formed on an inner peripheral surface and formed in an oval columnar shape to an oval-shaped through hole pierced in the lens of the eyeglasses from one side of the eyeglasses, and screwing a fastening having a male screw to the female screw in the inserting and fitting columnar body from another side of the lens. In particular, in FIG. 16 and a paragraph [0029] describing FIG. 16, and FIG. 19 and paragraphs [0033] to [0034] describing FIG. 19 in the publication mentioned above, there is shown an example that the inserting and fitting columnar body and the end piece are constituted by independent parts.

Further, in the connection portion among a pad, a pad arm, the closing block and the like and a connection portion between the skull temple and the end piece, there are generally employed a method of arranging a through hole in a part of each of the members to be connected and passing the male screw to the through hole so as to connect by a through nut, or a method of directly forming a female screw in an inner portion of the hole passing through the member to be connected and engaging the male screw with the female screw, thereby connecting a plurality of members.

In the screw locking structure of the eyeglasses frame described in JP-A-10-170872, the upper and lower rims are connected by inserting and fitting a pipe having a female screw formed on an inner peripheral surface to the hole passing through the closing block portion from one side, and screwing the male screw with the female screw from another side. In this pipe, in order to prevent come-off caused by fastening the screw, a taper is formed on a collar or an outer peripheral surface.

Accompanying with a weight saving of the spectators, a lighter material is required for the eyeglasses frame parts such as the bridge, the rim, the skull temple and the like, for example, an application of magnesium is considered. The magnesium is light, but has a low hardness in comparison with the other metals used for the conventional eyeglasses parts. When connecting the eyeglasses parts made of the material having the low hardness by means of the screw, a great stress is applied to the screw hole passing through the member for inserting the screw. Accordingly, there is a risk that the screw is loosened or the screw hole is deformed because of a long time use of the eyeglasses, and by extension, the eyeglasses parts are broken.

In order to prevent the eyeglasses parts from being broken, it is considered a method of reinforcing the screw hole. In the lens mounting structure described in JP-A-2000-105356 listed above, the screw hole is reinforced by using the inserting and fitting columnar body formed in the oval columnar shape.

In this lens mounting structure, the hole for inserting and fitting the inserting and fitting columnar body pierced in the eyeglasses lens is a straight hole. Accordingly, an outer peripheral surface of the inserting and fitting columnar body does not transmit a force generated in a direction of fastening the male screw to an inner peripheral surface of the hole, the force is concentrated to a front face portion in each of the lens and the eyeglasses frame part in which the male screw and the inserting and fitting columnar body is in contact with the lens, and there is a risk that the loosening of the male screw caused by a breakage of the parts or a plastic deformation of the parts is generated in the case of fastening the eyeglasses frame part made of a particularly soft material. Further, in order to engage the inserting and fitting columnar body with the end piece, an engagement portion has a complex shape, for example, a plurality of step portions are formed in a collar portion in the inserting and fitting columnar body, so that it is not easy to work. Further, since the lens surface is formed in a curved shape, it is hard to completely close contact the flat surface of the end piece with the lens surface so as to face them to each other, and there is a risk that a small gap between the end piece and the len's surface causes a slack of the screw. When a closely contact member such as a pad, a washer or the like is used for the purpose of doing away with the gap, a number of the parts is increased, and a manufacturing process and a cost are increased at that degree.

In the screw locking structure of the eyeglasses frame described in JP-A-10-170872, the threaded hole is reinforced by the pipe with the collar, however, since a force is concentrated on the pipe with the collar in a direction of fastening the screw in the same manner as that of the reinforcing member of the inserting and fitting columnar body, there is a problem that fastening too tightly causes damage to the member. That is, the fastening force of the screw is applied only to the collar portion of the pipe in the eyeglasses parts, and a great force applied to this portion scratches the eyeglasses parts, and the force is not sufficient in view of an engagement between the pipe and the eyeglasses parts at a time of engaging the parts with each other.

In the pipe with the taper on the outer peripheral surface corresponding to another reinforcing member disclosed in JP-A-10-170872, since the stress in the direction of fastening the screw is dispersed with respect to the outer peripheral surface of the hole at a degree of an angle of the taper, a change of damaging the member to be connected is low. However, if the angle of the taper is too acute, the pipe comes off from the through hole due to the fastening of the screw. Further, if the angle of the taper is obtuse, so large hole is pierced in the eyeglasses parts to be connected, whereby a strength of the eyeglasses itself is lowered. Accordingly, in order to close fit the reinforcing member to the eyeglasses parts, it is necessary to consider the angle of the taper provided in the reinforcing member, a size of the reinforcing member itself, and the like.

### DISCLOSURE OF THE INVENTION

An object of the present invention is to prevent a slack of a screw used in an eyeglasses. Further, another object of the present invention is to prevent an eyeglasses lens and eyeglasses frame parts from rotating around a screw connection portion at a time of connecting the eyeglasses lens and the eyeglasses frame parts, in the eyeglasses supported by two points.

In accordance with the present invention, in order to connect the eyeglasses parts such as the eyeglasses lens, the eyeglasses frame parts and the like to each other, a taper nut is used in a portion in which a male screw and a female screw are screwed. The taper nut is fitted to a hole having a taper provided in the eyeglasses parts, thereby being fixed so as not to easily rotate in the eyeglasses lens and the eyeglasses frame parts. Further, two or more eyeglasses parts are connected to each other by passing the male screw (a bolt) to a through hole provided in the other eyeglasses parts and engaging the female screw provided on a center axis of the taper nut with the male screw inserted to the through hole.

A taper angle of a hole having a taper provided in the eyeglasses part is approximately equal to a taper angle of the taper nut. By taking an angle of incline of the taper into consideration, the structure can be made such that the taper nut does not easily rotate once being fitted to the eyeglasses parts, and does not easily fall off from the eyeglasses parts. Further, since the taper nut has the “collar” in an end portion in an expanded side of the taper, the taper nut does not get into under the eyeglasses parts more than necessary even in the case of being strongly fastened. Further, this “collar” transmits the fastening force by the screw in a direction of connecting the eyeglasses parts to each other.

In the case that the taper nut is used for connecting the eyeglasses parts to each other, the taper nut firmly fixed to the eyeglasses parts without sliding securely transmits the fastening force of the screw, so that it is possible to fix the eyeglasses parts to each other more firmly. Further, since the taper nut is fixed so as not to easily rotate in the eyeglasses parts, it is possible to prevent the eyeglasses parts from rotating with respect to each other by a simple connecting structure. Accordingly, since the connecting parts of the eyeglasses, in particular, the connecting structure between the eyeglasses lens and the eyeglasses frame parts such as the end piece, the bridge and the like becomes simple, a degree of freedom in design of the eyeglasses is increased, and it is possible to manufacture the eyeglasses having a novel design.

In accordance with the present invention, the taper nut is used for connecting rims to each other in a closing block. In this case, the invention is disclosed with respect to a case that a leading end portion of the taper nut reaches the rim to which the taper nut is not fitted, and a case that the leading end portion does not reach there.

In accordance with the present invention, the taper nut is used for connecting an end piece to a skull temple in the eyeglasses parts. The skull temple is gripped by parts of branched end pieces, and through holes are provided in the parts of the end piece and the skull temple. A taper is provided in the through hole formed in the part of the end piece, and the taper nut is fitted to the taper in a state of gripping the skull temple. Further, the end piece and the skull temple are connected by inserting a male screw (a bolt) to the part of the end piece from an opposite side to a side from which the taper nut is fitted, and fastening the male screw to a female screw portion of the taper nut.

In accordance with the present invention, the skull temple and the end piece freely rotate, and it is possible to firmly fix both the eyeglasses parts by the taper nut which is close fitted to the end piece.

In accordance with the present invention, the taper nut is used for connecting the eyeglasses frame to the eyeglasses frame parts such as the end piece, the bridge and the like. A hole having a taper is provided in one of the eyeglasses lens and the eyeglasses frame part, and the taper nut is fitted to the hole. A through hole is pierced in another eyeglasses part, and the eyeglasses lens and the eyeglasses frame part are faced to each other so that the hole having the taper and the through hole are aligned with each other. A female screw is formed on an inner peripheral surface of the taper nut, the male screw (the bolt) is engaged with the female screw from a leading end portion having no collar in the taper nut, thereby connecting the eyeglasses lens to the eyeglasses frame part.

Otherwise, in accordance with the present invention, the holes having the tapers are pierced in both the eyeglasses lens and the eyeglasses frame part, and the eyeglasses lens and the eyeglasses frame part are connected by fitting the taper nut to both the eyeglasses parts in a state of facing these eyeglasses parts to each other so that positions of the holes are aligned, and fastening the male screw (the bolt) from the leading end portion having no collar in the taper nut.

In accordance with the present invention, it is possible to connect the eyeglasses lens to the eyeglasses frame part on the basis of a simple structure without charging any additional part. Further, in the case that the holes having the tapers are pierced in both the eyeglasses lens and the eyeglasses frame part, both the parts are fixed by the taper nut, so that it is possible to prevent these parts from rotating, without providing with any special mechanism for preventing the eyeglasses lens and the eyeglasses frame part from rotating with respect to each other.

### BRIEF DESCRIPTION OF THE DRAWINGS

FIG. 1 is an eyeglasses in which a closing block is connected by using a taper nut in accordance with an embodiment of the present invention;

FIG. 2 is an enlarged view of a portion X in FIG. 1, and shows a connection structure of a closing block using a taper nut in accordance with an embodiment of the present invention;

FIG. 3 is a schematic view of a taper nut used in the present invention;

FIG. 4 is an enlarged view of a portion X in FIG. 1, and shows a connection structure of a closing block using a taper nut in accordance with a different embodiment from the embodiment in FIG. 2 of the present invention;

FIG. 5 is a view showing a relation of connection among an eyeglasses lens, a bridge and an end piece;

FIG. 6 is a transverse sectional view showing a relation of connection between the eyeglasses lens and the bridge or the end piece using the taper nut in accordance with the embodiment of the present invention;

FIG. 7 is an enlarged view of a portion Y in FIG. 6, and shows a connection structure of an eyeglasses lens using a taper nut in accordance with an embodiment of the present invention;

FIG. 8 is an enlarged view of a portion Y in FIG. 6, and shows a connection structure between the eyeglasses lens and the eyeglasses frame part using a taper nut in accordance with an embodiment of the present invention;

FIG. 9 is a view showing an embodiment in a case that a direction of inserting and fitting the taper nut is changed, with respect to the embodiment shown in FIG. 8;

FIG. 10 is a view showing an embodiment in a case that a washer is used, with respect to the embodiment shown in FIG. 8;

FIG. 11 is a view showing an embodiment in a case that a soft member is used for the taper nut, with respect to the embodiment shown in FIG. 8;

FIG. 12 is a view showing a state in which the eyeglasses lens and the bridge or the end piece are connected by using the taper nut and a tapered bolt;

FIG. 13 is a view showing an embodiment in a case that a nut is used, with respect to the embodiment shown in FIG. 12;

FIG. 14 is a view showing a state in which the eyeglasses lens and the bridge or the end piece are connected by using a taper nut having a hole in which a taper is formed on an inner peripheral surface;

FIG. 15 is a view showing an embodiment in a case that a direction of inserting and fitting the taper nut is changed, with respect to the embodiment shown in FIG. 14;

FIG. 16 is a transverse sectional view showing a relation of connection between the eyeglasses lens and the bridge or the end piece using a taper nut in accordance with an embodiment of the present invention;

FIG. 17 is a transverse sectional view showing a relation of connection between the eyeglasses lens and the bridge or the end piece using a taper nut in accordance with a different embodiment of the present invention from the embodiment in FIG. 6;

FIG. 18 is an enlarged view of a portion V in FIG. 17, and shows a connection structure of an eyeglasses lens using a taper nut in accordance with an embodiment of the present invention;

FIG. 19 is a view showing a hinge screw connecting the skull temple and the end piece;

FIG. 20 is an enlarged view of a portion Z in FIG. 19, and an enlarged view (part 1) of a cross section of the hinge screw using the taper nut in accordance with the embodiment of the present invention;

FIG. 21 is an enlarged view of the portion Z in FIG. 19, and an enlarged view (part 2) of the cross section of the hinge screw using the taper nut in accordance with the embodiment of the present invention;

FIG. 22 is a view showing a method of adjusting a fastening strength of a screw (part 1), in the connection structure of the eyeglasses parts using the taper nut in accordance with the embodiment of the present invention;

FIG. 23 is a view showing a method of adjusting the fastening strength of the screw (part 2), in the connection structure of the eyeglasses parts using the taper nut in accordance with the embodiment of the present invention;

FIG. 24 is a view showing a connection structure among an eyeglasses lens, a bridge and an end piece in accordance with a conventional art; and

FIG. 25 is an enlarged view of a portion W in FIG. 24, and shows a connection structure among the eyeglasses lens, the bridge and the end piece in accordance with the conventional art.

### BEST MODE FOR CARRYING OUT THE INVENTION

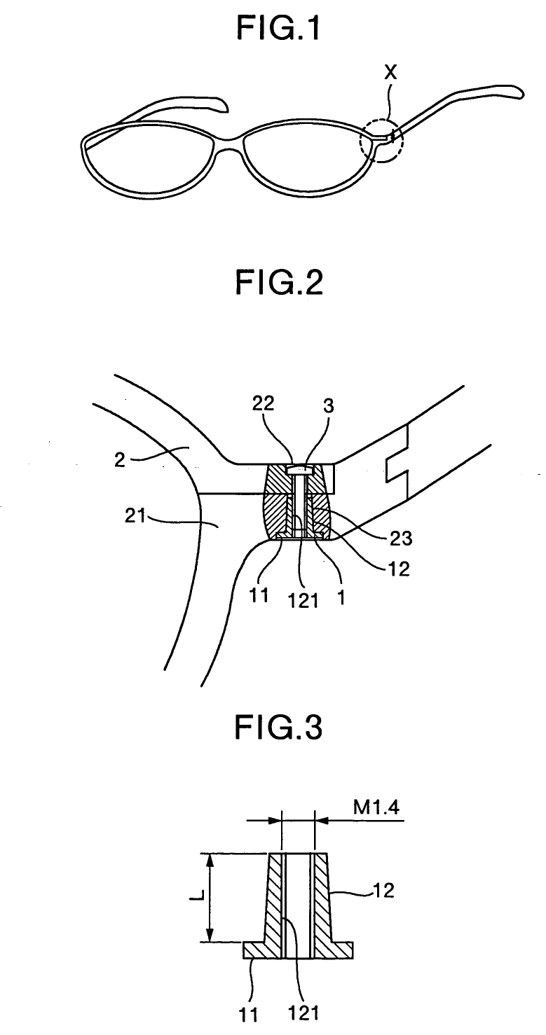

FIG. 1 illustrates an eyeglasses in which a taper nut corresponding to a taper piece with a female screw in accordance with an embodiment of the present invention is used in a closing block shown in a portion X surrounded by a single-dot chain line, ad FIG. 2 is an enlarged view of the portion X. A taper nut 1 corresponding to the taper piece with the female screw has a taper portion 12 and a collar portion 11 as shown in FIG. 3, and an operation of this portion is disclosed in FIG. 1 and paragraphs [0027] to [0034] in JP-A-9-287609 filed by the applicant of this patent application. That is, the taper portion 12 has a circular truncated cone shape on an outer face thereof, and the collar portion 11 is formed in an enlarged side portion of the taper portion. Further, a lower face of the collar portion 11 is orthogonal to an axial direction of the taper portion 12. Further, a female screw 121 is previously formed in an inner portion of the taper nut 1, and a center axis of the female screw 121 exists on a center axis of the taper portion 12.

An outline of an operation for fitting and attaching the taper nut to a connection member is shown in FIG. 5 and paragraphs [0041] to [0050] in JP-A-9-287609. That is, a hole 23 for inserting the taper nut 1 is worked and formed in a member to be connected (a rim 21 in FIG. 2) by using an exclusive formed drill. Accordingly, a hole taper portion and a hole step portion are formed in the hole 23.

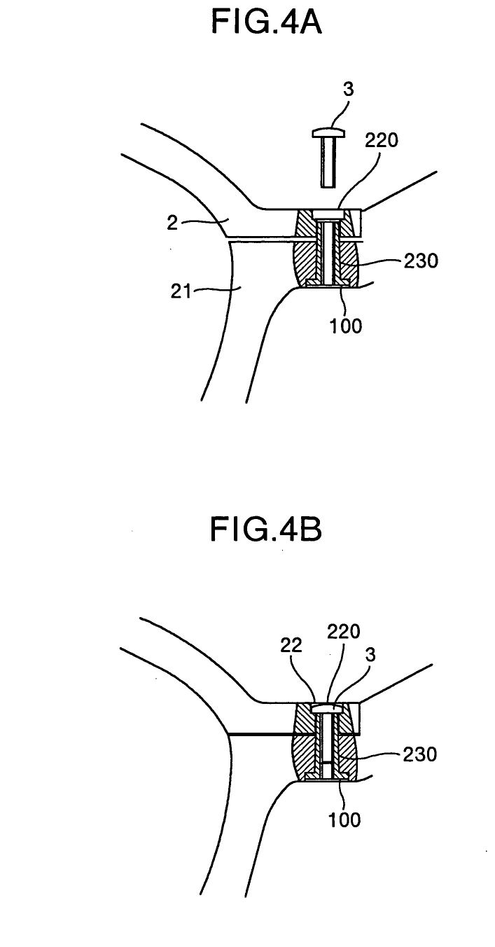

A female screw guide hole portion and a hole dead end chamfer portion may be formed in this hole, as shown in FIG. 4 and paragraphs [0038] to [0039] in JP-A-9-287609. The taper portion 12 of the taper nut 1 inserted to this hole 23 has such a size that the taper portion 12 lightly close fits to the hole taper portion of the fitted hole 23. That is, in a state in which the taper nut 1 is simply put over the hole 23, a lower face of the collar portion 11 float up from the hole step portion of the hole 23. Since the hole taper portion of the hole 23 and the taper portion 12 of the taper nut 1 are engaged, a center axis of the hole 23 coincides with a center axis of the taper nut 1. Therefore, an axial center of the taper nut 1 is orthogonal to a surface of the rim 21 by forming the hole 23 so as to be orthogonal to the surface of the rim 21. It is possible to easily make the center axis of the female screw 121 orthogonal with the surface of the rim 21 by coinciding an axial center of the female screw 121 formed in the taper nut 1 with an axial center of the taper portion 12. Further, the taper nut 1 is driven into the hole 23 formed in the rim 21 by striking an upper face of the collar portion 11 in the taper nut 1 by using a driving hammer or the like, and a lower face of the collar portion 11 is brought into contact with the hole step portion of the hole 23 and then stops.

In this case, since the taper nut for the eyeglasses in accordance with an embodiment of the present invention is small, it is possible to insert the taper nut 1 to the hole 23 by a human power without using the driving hammer. Since it is easy to press the nut having the taper shape into the eyeglasses part, it is possible to inhibit the screw from being loosened without making the manufacturing process of the eyeglasses complex. Further, the taper nut fitted and attached to the rim 21 does not fall off from the rim 21 even in a state in which the taper nut is not fastened by the male screw 3, and if the engagement with the male screw 3 comes off during the use of the eyeglasses, the taper nut 1 does not come off from the rim 21 and is not lost.

A length of the taper nut 1 used in the closing block in FIG. 2 is shorter than a depth of the hole 23, and the leading end of the taper nut 1 driven into the rim 21 reaches a middle of the rim 21 and stops. That is, the leading end portion of the taper nut 1 corresponding to an end portion in a side that a taper is reduced is not in contact with the rim 2. Not applying only to the embodiment in FIG. 2, in the case that that the leading end portion of the taper nut corresponding to the end portion in the side of the taper portion is reduced does not protrude from the eyeglasses part in the side to which the taper nut is fitted and attached, it is sufficient to form a hole having a hole diameter through which the male screw passes, in another part (the rim 2 in FIG. 2). That is, it is sufficient to pierce the hole 23 in the rim 21 in FIG. 2 by using an exclusive formed drill for fitting and attaching the taper nut 1, and to pierce the hole 22 for passing the male screw 3 therethrough in the rim 2, in accordance with respective independent processes. As mentioned above, since it is not necessary to coincide the hole diameter of the hole 23 pieced in the rim 21 with the hole diameter of the hole 22 pierced in the rim 2, it is not necessary to align the rims 2 and 21 with each other so as to simultaneously work the holes by the drill or the like, so that it is possible to simplify the process of working the holes. Further, as not applying only to the embodiment in FIG. 2, since the taper nut 1 is in surface contact with the hole 23 in the taper portion 12, and is under a state of being close fitted to the rim 21, the taper nut 1 is not loosened or rotated with respect to the rim 21, and the slack of the screw is hard to be generated even in the case that the rims 2 and 21 are connected by the male screw 3.

In FIGS. 4A and 4B, a taper nut 100 is fitted to a taper-shaped hole 230 pierced in the rim 21 in accordance with the method mentioned above. A hole 220 having approximately the same taper shape as that of the male screw 3 and a taper portion of the taper nut 100 is pieced by an exclusive formed drill, and the male screw 3 and the taper nut 100 are screwed with each other through the hole 220. In the case that the male screw 3 employs a screw of M1.4 (an outer diameter of a male screw portion is 1.4 mm) which is standardized in size as a screw for the eyeglasses, since an already circulating part can be used, it is possible to reduce a cost in time and economy for newly developing a screw for exclusive use of the taper nut.

In the case that the taper nut is applied to a very small screw equal to or less than M2.0 (an outer diameter of the male screw portion is 2.0 mm) such as the screw for the eyeglasses, it is suitable that a margin for a close fit corresponding to an amount that the collar portion of the taper nut floats above the hole at a time of putting the taper nut over the tapered hole lightly, is set to about 0.05 to 0.3 mm. Further, in order to make the taper nut be easily driven and be held at a high reliability after being driven, a value of the taper is preferably set to about 1/30 to 1/15.

An entire length of the taper nut 100 shown in FIG. 4B is longer than that of the taper nut 1 shown in FIG. 2, and a leading end of the taper nut 100 reaches a middle of the rim 2. Accordingly, the hole 220 provided in the rim 2 has such a hole diameter that the leading end portion of the taper nut 100 is received there. In accordance with this embodiment, the holes 230 and 220 may be simultaneously formed by using the exclusive formed drill in a state in which the rims 2 and 21 are faced to each other. In this case, the hole 220 is formed partway without penetrating, and the hole for passing the male screw 3 therethrough is pieced in the rim 2 from an opposite side to a side in which the taper is formed, in accordance with the independent process. Accordingly, the taper is formed in a part of the hole 220, and when fitting and attaching the taper nut 100 in a state in which the rims 2 and 21 are faced, the taper nut 100 is in a state of a close fit not only with respect to the rim 21 but also with respect to the rim 2. Further, it is possible to more firmly connect the rims 2 and 21 by fastening the male screw 3 inserted to the hole 220. In this case, the hole 220 may be a straight hole having no taper.

It is assumed that a titanium or a magnesium is used for a material of the rims 2 and 21 corresponding to a part of the eyeglasses frame for the purpose of saving a weight of the eyeglasses. However, in this case, it is suitable to employ the same material as the material used in the rims 2 and 21 or a material having a higher hardness than that of the rim material, for the taper nut 1. In the case that the titanium is used in the rims 2 and 21, it is proper that the material of the taper nut 1 employs the titanium or a material having a higher hardness than that of the titanium. Further, if the magnesium, a stainless steel, a yohaku having a good working property, a cobalt, a plastic or the like is used for the rims 2 and 21, it is desirable to select the titanium, the stainless steel, a rigid plastic or the like having a higher hardness than the above materials, for the material of the taper nut 1.

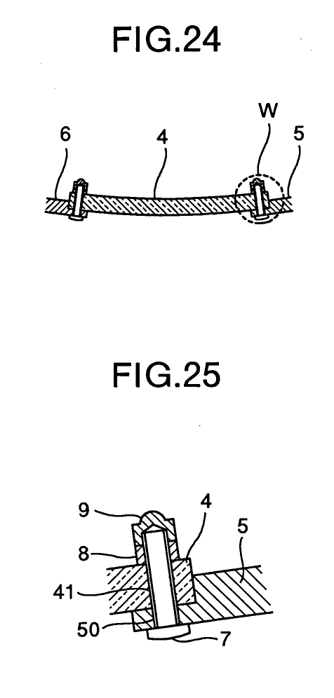

FIG. 5 shows a state in which a bridge 6 and an eyeglasses lens 4, and the eyeglasses lens 4 and an end piece 5 are respectively connected by using screws, in a rimless eyeglasses. In accordance with the conventional method shown in FIG. 24 and FIG. 25 which shows a portion W surrounded by a single-dot chain line in FIG. 24 in an enlarged manner, the holes 50 and 41 are pieced respectively in the end piece 5 and the eyeglasses lens 4, the male screw 7 is inserted to the holes 50 and 41 from an opposite side to a side in which the eyeglasses lens 4 faces to a human face, and the nut 8 is screwed with the male screw 7 from the side in which the eyeglasses lens 4 faces to the human face, whereby the eyeglasses lens 4 and the end piece 5 are connected. Here, in the case that the male screw 7 protrudes toward the human face, a safety at a time of wearing the eyeglasses is increased by attaching the cap 9 thereto. However, in accordance with this conventional method, since the male screw 7 protrudes toward the human face at least by a thickness of the nut 8, it is hard to clean the eyeglasses, and when the human wearing the eyeglasses tumbles or the like, there is a risk that the human face is injured by this protruding portion, the protruding portion comes into the eyes, or the like.

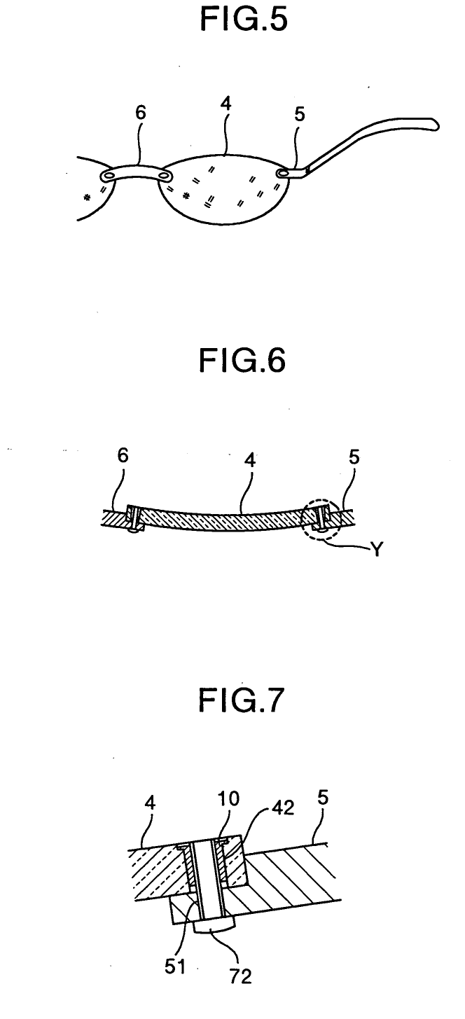

On the contrary, in accordance with a structure in which the eyeglasses lens 4 and the end piece or the eyeglasses lens and the bridge 6 are connected by using the taper nut 10 shown in FIG. 6 and FIG. 7 showing a portion Y surrounded by a single-dot chain line in FIG. 6 in an enlarged manner, a hole 42 for fitting the taper nut 10 by using the exclusive formed drill is formed in the eyeglasses lens 4, and the taper nut 10 is buried in the hole 42. The hole 42 is a hole having a taper of approximately the same angle as that of the taper portion of the taper nut 10 fitted to the hole 42, and is formed by an exclusive formed drill or the like.

Since the taper nut 10 is buried in the hole 42, an upper end portion of the taper nut 10 can be positioned on the same level as the surface of the eyeglasses lens 4 or below the surface of the eyeglasses lens 4. Further, it is possible to prevent the male screw 72 from protruding toward the human face or inhibit the protruding length, by adjusting the length of the male screw 72. Accordingly, it is possible to get a broader point of view at a time of wearing the eyeglasses, it is easy to clean the lens, and there is no fear that the human face and the eyes are injured by the taper nut 10 and the male screw 72 at a time when the wearer falls over or an impact is applied to the eyeglasses.

Further, in the eyeglasses lens 4, since a specific curvature and curve are formed on a surface thereof in correspondence to a power and a design, there is a case that an air gap is generated in a grip portion gripped in accordance with a conventional method of fixing the eyeglasses lens 4 by a mechanism of gripping the eyeglasses lens 4 between the end piece 5 and a part of the bridge 6, and there is a risk that the eyeglasses parts slide at a degree of the air gap, thereby causing a slack of the screw. However, in the embodiment shown in FIG. 7, since the taper nut 10 is used in a state of being buried in the eyeglasses lens 4, the taper nut 10 is fixed to the eyeglasses lens 4 on the basis of the close fit of the hole 42 formed in the eyeglasses lens 4, so that the slack is hard to be generated.

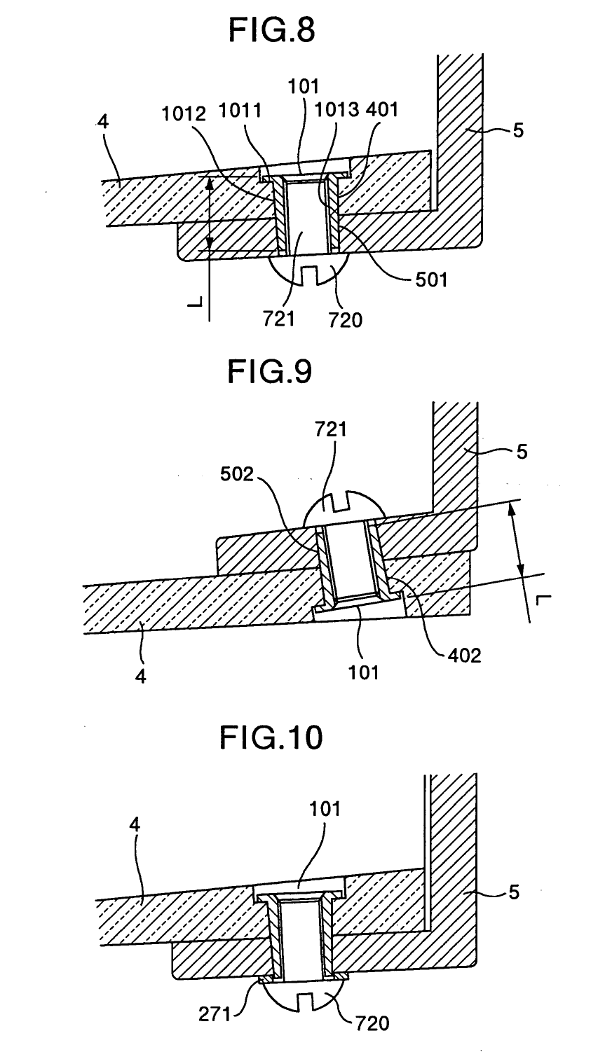

On the other hand, in the embodiment shown in FIG. 8, a hole 401 having a taper for fitting and attaching a taper nut 101 to the eyeglasses lens 4 is pieced so as to be expanded and opened to the side of the eyeglasses lens 4 facing to the human face. In the same manner, a hole 501 having a taper is pierced in the end piece 5 so as to be expanded and opened to the side in contact with the eyeglasses lens 4. In this embodiment, the taper nut 101 is fitted and attached to these holes 401 and 501 in a close fit manner. Further, the eyeglasses lens 4 and the end piece 5 are connected by passing a male screw 720 through the hole 501 from the side of the end piece 5 not facing to the eyeglasses lens 4, engaging the male screw 720 with a female screw 1013 formed on an inner peripheral face of the taper nut 101 and fastening the male screw 720.

With respect to the hole 501 provided in the end piece 5, the formed drill is inserted halfway to the end piece 5 so as not to form a hole step portion. Finally, the hole 501 provided in the end piece 5 may be fine adjusted by manually rotating the drill or the like, so that the eyeglasses lens 4 and the end piece 5 are firmly fitted and attached to the taper nut 101.

As mentioned above, in accordance with the embodiment shown in FIG. 8, the taper nut 101 is in a close fit state with respect to the eyeglasses lens 4 and the end piece 5. That is, the taper nut 101 is fixed so that the taper nut 101 can not be rotated by a pressing force caused by a repulsive force from the taper surfaces of the holes 401 and 501, in a state in which the taper nut 101 if fitted to the hole 401 of the eyeglasses lens 4 and the hole 501 of the end piece 5. This conversely means that the eyeglasses lens 1 and the end piece 2 are prevented from rotating against the taper nut 5. It is possible to connect the eyeglasses lens 4 and the end piece 5 while preventing both the eyeglasses parts from rotating, by fitting the taper nut 101 to the tapered hole pierced in the eyeglasses lens 4 and the end piece 5, in the manner mentioned above.

FIG. 9 is a cross sectional view showing a state in which the end piece 5 is arranged in the side of the eyeglasses lens 4 facing to the human face, and both the parts are connected by using the taper nut 101. This is different from FIG. 8 in a point that an expanded and opened hole 402 is pierced in the side of the eyeglasses lens 4 not facing to the human face, as illustrated in the drawing. Accordingly, with respect to the hole 502 of the end piece 5, a taper is provided in an opposite direction to the hole 501 shown in FIG. 8, in correspondence to a direction of the taper provided in the hole 402 of the eyeglasses lens 4. An effect of preventing the eyeglasses lens 4 and the end piece 5 from rotating is generated by a strong friction force generated by the repulsive force between the taper nut fitted and attached to both the eyeglasses parts, and the hole 402 and the hole 502, as described in FIG. 8.

Further, in the embodiment in which the eyeglasses lens and the eyeglasses frame parts, as shown in FIGS. 8 and 9, the taper nut is not always fitted to the eyeglasses lens or the eyeglasses frame parts so as to be orthogonal thereto, in view of a relation of design in the eyeglasses.

FIG. 10 shows a countermeasure against the case that the leading end portion of the taper nut 101 protrudes from the end piece 5, in the mounting structure shown in FIG. 8. In this case, a fastening force of a male screw 720 fastened to the female screw of the taper nut 101 is transmitted to the end piece 5 via a washer 271, by placing the washer 271 under the male screw 720 as shown in FIG. 10, and the eyeglasses lens 4 and the end piece 5 are firmly fixed as in the embodiment shown in FIG. 8. An effect of preventing the eyeglasses lens 4 and the end piece 5 from rotating in this embodiment is caused by a close fit of the taper nut 101 with respect to the eyeglasses lens 4 and the end piece 5, as shown in FIG. 8.

The embodiment shown in FIG. 10 corresponds to the embodiment in FIG. 8. In the case that a direction of fitting and attaching the taper nut is opposite to that in FIG. 10 in correspondence to the embodiment in FIG. 9, it is possible to connect the eyeglasses frame parts such as the eyeglasses lens 4 and the end piece 5 by using the washer 271, in the same manner.

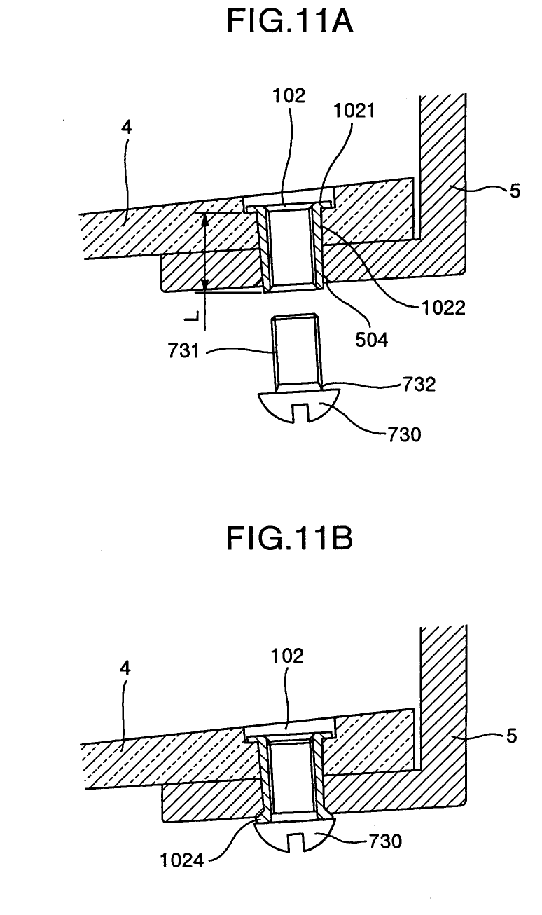

FIG. 11 is a view showing an embodiment in the case that an easily deformable soft material is used for a material of the taper nut 102, the embodiment in which a mounting structure is similar to the embodiment described in FIG. 8. In FIG. 11A, as in the embodiment described in FIG. 10, a lower end of the taper nut 102 protrudes from the end piece 5. In this case, a chamfer portion 504 is provided in an opening portion of a hole formed in the end piece 5. Further, since a nylon resin material such as a polyacetal, a juracon or the like is used for a material of the taper nut 102, a leading end portion 1024 of the taper nut 102 is deformed while expanding so as to clog the chamfer portion 504 in accordance with fastening a male screw 730, as shown in FIG. 11B. Since this deformed leading end portion 1024 transmits a fastening force in a direction of the eyeglasses lens 4 generated by the male screw 730 to the end piece 5 via the chamfer portion 504, the eyeglasses lens 4 and the end piece 5 are firmly fixed.

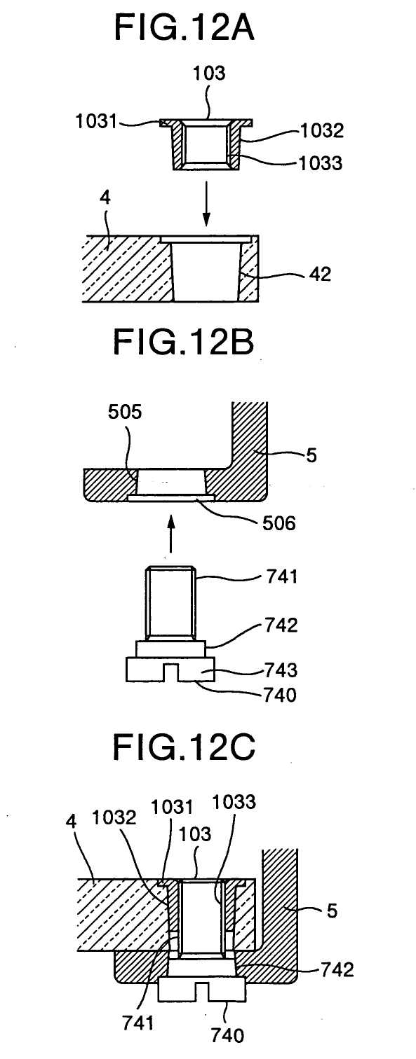

FIG. 12 is a view describing an embodiment in the case that a male screw 740 has a taper portion 742. A taper which is reduced in a direction of moving from a screw head 743 to a threaded portion 741, that is, a direction in which the male screw 740 moves by fastening the male screw 740, is formed in this taper portion 742. As shown in FIG. 12A, the eyeglasses lens 4 is provided with a hole 42 having a taper so as to be expanded and opened to the surface in the side not being in contact with the end piece 5, and a taper nut 103 is fitted and attached to the hole 42. In accordance with this embodiment, as shown in FIG. 12C, a leading end portion of the taper nut 103 fitted to the eyeglasses lens 4 in a reducing direction of a taper portion 1032 reaches a halfway of the eyeglasses lens 4 and stops there, so that the leading end portion does not reach the end piece 5. Further, a hole 505 having a taper so as to be expanded and opened to the surface in the side not being in contact with the eyeglasses lens 4 is pierced in the end piece 5, as shown in FIG. 12B. In the embodiment shown in FIG. 12, a hole step portion 506 is provided in the hole 505, however, the structure may be made such that the hole step portion 506 is not provided as occasion demands.

Then, as shown in FIG. 12C, the eyeglasses lens 4 and the end piece 5 are connected by screwing the male screw 740 passing through the hole 505 with a female screw portion 1033 of the taper nut 103 fitted to the eyeglasses lens 4. In this case, the eyeglasses lens 4 is fixed to the taper nut 103 so as not to rotate freely on the basis of a friction force of the taper surface of the taper nut 103. Further, owing to a friction force between the taper portion 742 of the male screw 74 and the taper surface of the hole 505, the end piece 5 can not easily rotate with respect to the male screw 74. That is, in this embodiment, the eyeglasses parts are fixed so as not to easily rotate while both the taper nut 103 and the male screw 74 are connected, by firmly fastening the taper nut 103 and the male screw 74.

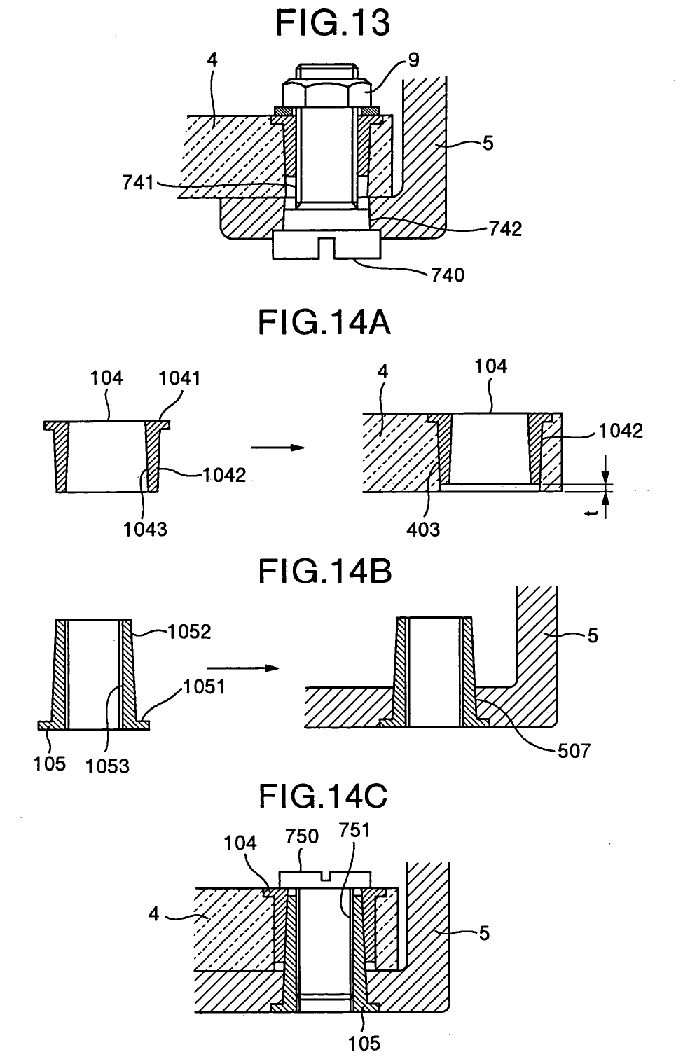

In FIG. 12C, in the case that the screw leading end portion of the male screw 740 protrudes from the taper nut 103, the structure may be made such that the eyeglasses lens 4 and the eyeglasses frame parts are more firmly connected by engaging the screw leading end portion of the male screw 74 with the nut 9 and fastening them as shown in FIG. 13. In this case, a washer or the like may be appropriately interposed between the nut 9 and the taper nut 103 or the eyeglasses lens 4.

In the embodiment shown in FIGS. 12 and 13, the taper nut 103 is fitted from the side of the eyeglasses lens 4 facing to the human face. However, on the contrary, the structure may be made such that the eyeglasses lens 4 and the end piece 5 are positioned as shown in FIG. 9, and the taper nut 5 is fitted from the side of the end piece 5 facing to the human face.

FIG. 14 is a view describing an embodiment in which the eyeglasses 4 and the end piece 5 are connected by using a taper nut 104 and a taper nut 105. As shown in FIG. 14A, an inner peripheral surface of the taper nut 104 is provided with a taper hole 1043 in which a taper reduced in an opposite direction to a taper portion 1042 on an outer peripheral surface of the taper nut 104, that is, toward a collar portion 1041 is formed. Further, the taper nut 104 is fitted to a hole 403 provided with a taper so as to be expanded and opened to the side of the eyeglasses lens 4 not being in contact with the end piece 5. Further, as shown in FIG. 14B, the taper nut 104 having a female screw 1043 in an inner portion thereof is fitted and attached to a hole 507 provided with a taper which is expanded and opened to the side of the end piece 5 not being in contact with the eyeglasses lens 4.

Then, as shown in FIG. 14C, the eyeglasses lens 4 and the end piece 5 are connected by screwing a male screw 750 passing through the taper portion 1043 of the taper nut 104 with a female screw portion 1053 of the taper nut 105. At this time, a leading end portion of the taper portion 1052 of the taper nut 105 is fitted to the taper hole 1043 of the taper nut 104, and the taper nut 104 and the taper nut 105 are fixed so as not to freely rotate with each other.

A screw standardized M.1.4 (a diameter is 1.4 mm) is generally employed for the male screw 750 used in the eyeglasses parts, as mentioned above. Further, in the case of being used in a state in which the taper nut is fitted to the end piece 5, a size of the end piece 5 is small in some design of the eyeglasses, so that it is impossible to pierce the large hole 507 in the end piece 5 taking a strength of the eyeglasses into consideration. The size of the taper nut 105 is limited because of the above matters, however, the larger an area of the taper portion of the taper nut 105 is, the stronger friction force the taper portion generates, so that a fixing force becomes strong. Accordingly, in order to achieve an object of inhibiting the rotation between the parts, it is desirable to use a taper nut having a large peripheral area.

Therefore, the fixing force against the rotation between the taper nut 104 and the eyeglasses lens 4 can be strengthened by using the taper nut 104 having the larger peripheral area than that of the taper nut 105 together with the taper nut 105. In this case, when using the same metal material for the taper nut 104 and the taper nut 105, the taper nuts are firmly fixed to each other on the basis of a so-called “galling” phenomenon. Accordingly, it is possible to obtain a more advantageous effect for the operation of preventing the parts from rotating with each other. Further, the structure may be made such that an adhesive agent is applied to the hole 507 with which the taper nut 105 and the end piece 5 are in contact, thereby more strengthening the fixing between the taper nut 105 and the end piece 5.

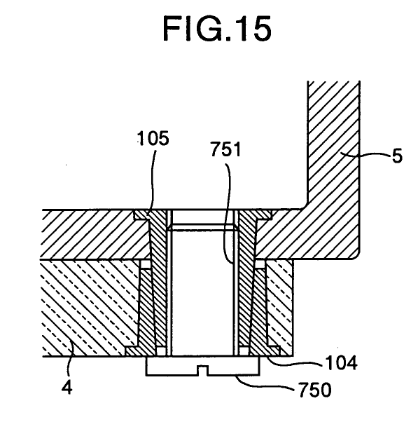

FIG. 15 shows an embodiment in which the directions of inserting two taper nuts 104 and 105 and the male screw 750 are replaced by each other, in the embodiment shown in FIG. 14C. The operations and effects thereof are the same as those of the embodiment described in FIG. 14. Further, in the case that the thickness of the eyeglasses lens 4 is thin, and the strength of the end piece 5 is sufficient, it is possible to use under an aspect that the taper nut 104 is fitted and attached to the end piece 5, and the taper nut 105 is fitted and attached to the eyeglasses lens 4.

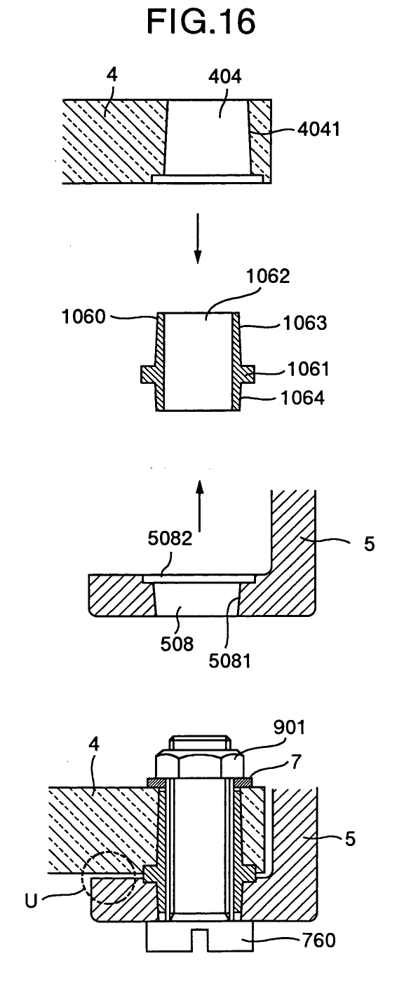

FIG. 16 is a view describing an embodiment in which the eyeglasses lens 4 and the end piece 5 are connected by using a taper nut 1060 having two taper portions comprising a taper portion 1063 and a taper portion 1064. The taper nut. 1060 has the taper portion 1063 and the taper portion 1064 which are constituted by a taper reducing in corresponding to moving apart from a collar portion 1061 on the boundary of the collar portion 1061, as shown in FIG. 11A. Further, a through hole 1062 for passing a bolt 760 therethrough is pierced on a center axis of the taper nut 1060. On the other hand, a hole 404 having a hole taper portion 4041 expanded and opened to the surface in the side facing to the end piece 5 is pierced in the eyeglasses lens 4. In the same manner, a hole 508 having a hole taper portion 5081 expanded and opened to the surface in the side facing to the eyeglasses lens 4 is provided in the end piece 5.

As shown in FIG. 16, the eyeglasses lens 4 and the end piece 5 are connected by passing the bolt 760 through the through hole 1062 in a state in which the taper portion 1063 of the taper nut 1060 is fitted to the hole taper portion 4041 of the eyeglasses lens 4, and the taper portion 1064 is fitted to the hole taper portion 5081 of the end piece 5 in the same manner, and fastening the bolt 760 by a nut 901 from an opposite side. At this time, the eyeglasses lens 4 and the end piece 5 are fixed so as not to rotate with each other, by the taper nut 1060 which is close fitted. Further, a gap is generated in a portion U surrounded by a single-dot chain line in FIG. 16C. This is because the taper nut 1060 may not be sufficiently fitted to both the eyeglasses parts, if the eyeglasses lens 4 and the end piece 5 are in contact with each other. However, it is possible to do away with this gap by fine adjusting the hole 404 and the hole 508.

In FIG. 16, the description is given of the embodiment in which the bolt 760 is inserted from the side of the end piece 5, however, the structure may be made such that the bolt 760 is inserted from the side of the eyeglasses lens 4, and is fastened by the nut 901 from the side of the end piece 5.

The embodiments shown in FIGS. 14, 15 and 16 are not limited to the connection between the eyeglasses lens and the eyeglasses frame parts, but can be, of course, applied to a connection of the other members than the eyeglasses and the parts.

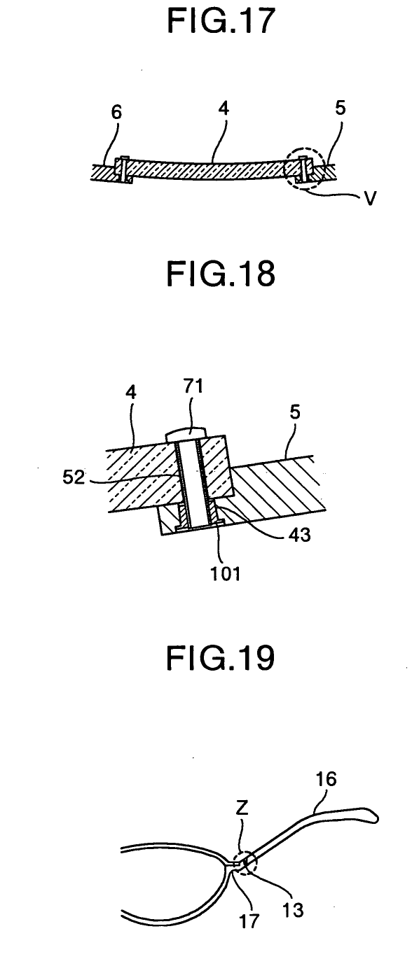

In addition, it is possible to make an embodiment shown in FIG. 17 and FIG. 18 showing a portion V surrounded by a single-dot chain line in FIG. 17 in an enlarged manner. In this embodiment, the hole 43 is pierced in the end piece 5 or the bridge 6 by the formed drill, the taper nut 101 is fitted and attached thereto, the holes 52 passing the male screw 71 therethrough is pieced in the eyeglasses lens 4, and both the parts are connected. However, in this embodiment, the screw head of the male screw 71 protrudes in the direction in which the eyeglasses lens 4 faces to the human face. Further, there is a case that there is generated a necessity of restricting the sizes of the end piece 5 and the bridge 6 small, owing to circumstances of securing a field of vision and designing a whole of the eyeglasses, so that there is a risk that the strength of the parts is lowered if the hole for fitting and attaching the taper nut is pieced there. On the other hand, since the eyeglasses lens 4 has fixed width and thickness in correspondence to the power thereof, it is easy to secure a place for forming the hole 42 which fits and attaches the taper nut 4. For these reasons, the embodiment in which the taper piece is fitted and attached to the eyeglasses lens 4 is excellent.

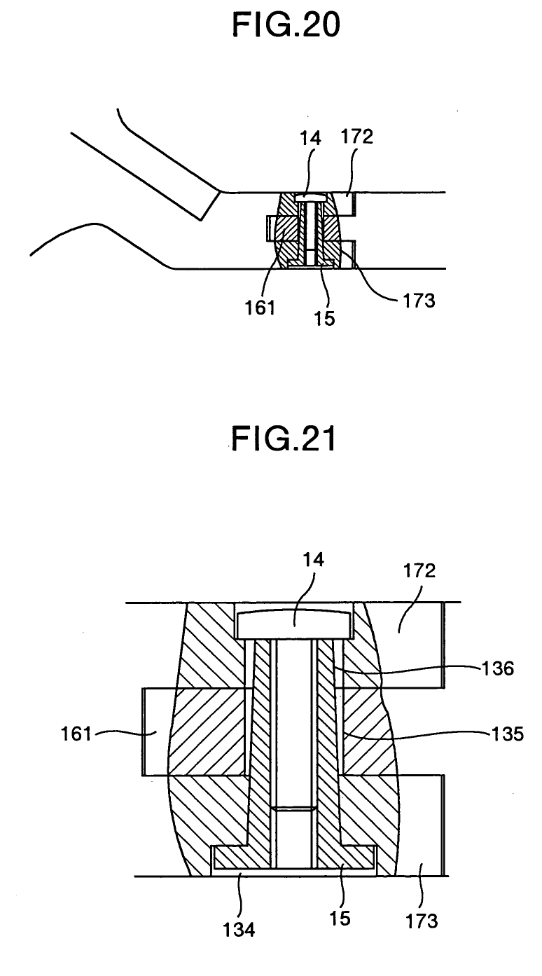

A glass or a plastic is frequently employed as the material for the eyeglasses lens 4, and in this case, it is desirable that a titanium, a stainless steel, a rigid plastic, a steel or the like is selected as the material for the taper nut 10. In an embodiment shown in FIGS. 18 and 20, it is desirable to select the same material as that of the case of the closing block mentioned above.

FIG. 19 is a view showing a hinge screw 13 of the eyeglasses, and FIGS. 20 and 21 are partly cross sectional views showing a portion Z surrounded by a single-dot chain line in FIG. 19 in an enlarged manner. A hole 134 having a taper is pierced in an end piece 173 by an exclusive formed drill for a taper nut 15, and the taper nut 15 is fitted and attached to the hole 134. Further, a straight hole 135 having no taper is pierced in a skull temple 161, and a countersunk straight hole 136 having no taper for a male screw 14 is pieced in the end piece 172. The end piece 17 and the skull temple 16 are connected by passing the taper nut 15 through these holes in the order of the holes 134, 135 and 136, passing the male screw 14 from a side of the hole 136 and screwing with a female screw in the taper nut 15.

The description is given above of the case in which no taper is provided in the hole 136, however, the taper may be provided in the hole 136. In this case, the holes 134 and 136 are formed by the formed drill. Since a leading end portion of the taper nut 15 and the end piece 172 are close attached by a close fit in the case that the hole 136 has the taper, a robbing between the end piece 172 and the taper nut 15 or the male screw 14 becomes small. Accordingly, this structure is preferable for preventing the end piece 172 from being worn. Further, in order to make the end piece 17 and the skull temple 16 slidable, it is preferable that the taper is not formed in the hole 135 pierced in the skull temple 161.

In this embodiment, since the taper nut 15 is in surface contact with the end piece 173 by the taper portion, the connection becomes hard to be slacked even when a stress caused by a sliding of the skull temple 161 is applied to the hinge screw 13. Further, the male screw 14 is fastened until the leading end of the taper nut 15 is in contact with the screw head of the male screw 14. In this case, if an entire length of the taper nut 15 and entire lengths and shapes of the holes 134, 135 and 136 are controlled so that the leading end of the screw head of the male screw 14 is in contact with the end piece 172 in this fastened state, it is possible to prevent the end piece 172 from being deformed by fastening the male screw 14.

Further, since the screw is fastened so that the screw head of the male screw 14 is in contact with the leading end portion of the taper nut, the slack of the screw is hard to be generated, so that it is possible to firmly connect the end piece 17 to the skull temple 16.

In FIG. 21, the structure is made such that the forked end piece 172 grips the skull temple 161, however, the structure may be made in an inverse manner such that the forked skull temple 161 grips the end piece 172.

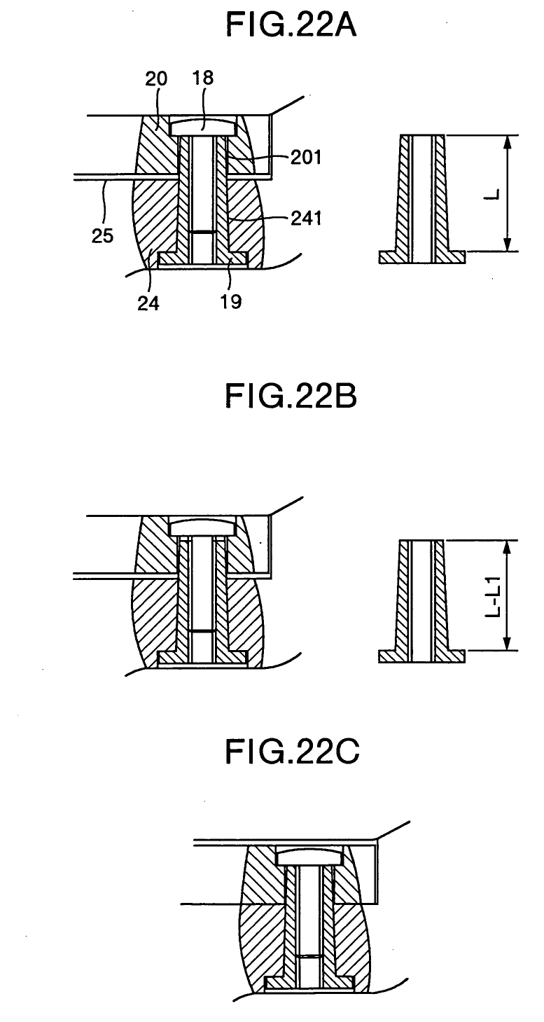

FIG. 22 illustrates a method of again reinforcing the connection in the case that the connection between eyeglasses parts 20 and 24 achieved by a taper nut 19 and a male screw 18 is slacked. In this drawing, the taper nut 19 is fitted and attached to a hole 241 worked and formed in the eyeglasses part 24 by an exclusive formed drill, and a leading end of the taper nut 19 reaches halfway in a hole 201 with no taper formed in the eyeglasses part 20. Then, the eyeglasses parts 20 and 24 are connected by screwing the male screw 18 and the taper nut 19 so as to pass through the hole 201 of the eyeglasses part 20.

In FIG. 22A, there is shown a state in which a gap 25 is generated between the eyeglasses parts 20 and 24, and the connection between both the parts is slacked. This slack is generated by an abrasion of the eyeglasses part 20 due to a contact between the male screw 18 and the eyeglasses part 20, or between the taper nut 19 and the eyeglasses part 20, or by a slack of engagement between the male screw 18 and the female screw of the taper nut 19. In this case, on the assumption that a length along a center axis of the taper portion in the taper nut 19 is set to L, in the case of employing a taper nut 26 having the same taper angle and having a length along the center axis of the taper portion shorter than the length L by a length L1 in place of the taper nut 19, as shown in FIG. 22B, the male screw 18 is deeply engaged with the taper nut 26 by the length L1, and the eyeglasses parts 20 and 25 are again firmly connected, as shown in FIG. 22C.

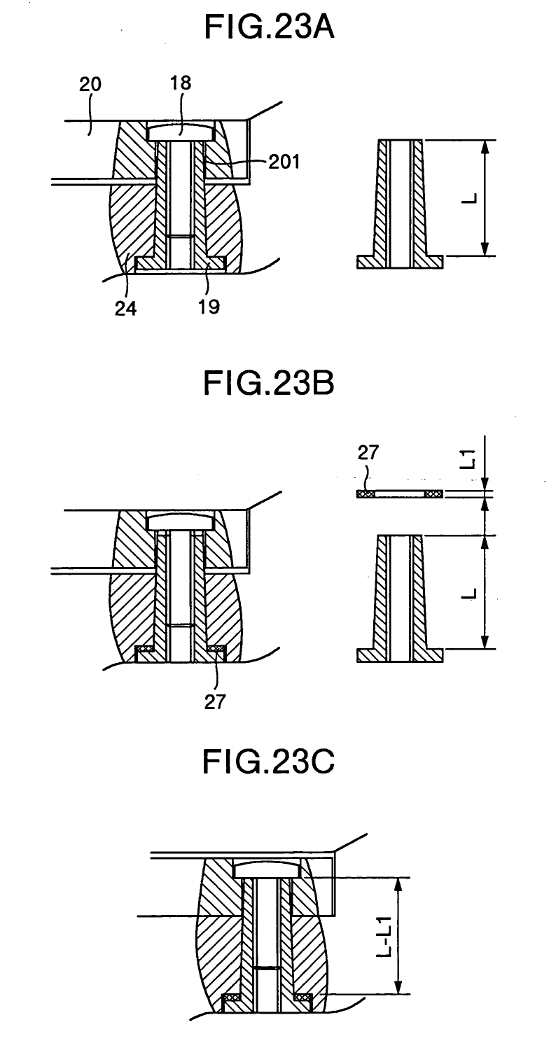

FIG. 23 illustrates another method of again reinforcing the connection in the case that the connection between eyeglasses parts 20 and 24 achieved by the taper nut 19 and the male screw 18 is slacked. The connecting structure between the eyeglasses parts 20 and 24 is the same as that shown in FIG. 22. In the method shown in FIG. 23, in place of replacing by the taper nut 19 by the taper nut having the shorter length in the direction of the center axis, a collar 27 having a thickness L1 shown in FIG. 23B is interposed between a collar of the taper nut 19 and the eyeglasses part 24. Accordingly, since the leading end of the taper nut 19 reaches a place set far back from the side of the male screw 18 by the length L1 within the hole 201 of the eyeglasses part 20, the male screw 18 is deeply screwed with the taper nut 19 by the length L1, and the eyeglasses parts 20 and 24 are again connected as shown in FIG. 23C.

The terms expressing the eyeglasses parts used in the present specification correspond to Japanese Industrial Standard (JIS7280), however, the embodiments in accordance with the present invention can be applied to the other eyeglasses parts than the eyeglasses parts defined by illustration in this standard as far as the parts has the same function as the eyeglasses parts shown in Japanese Industrial Standard. Further, the present invention can be applied to the other connections between the other eyeglasses parts than the connection between the eyeglasses lens and the end piece or the bridge, or in the closing block and the hinge screw.

Further, the present invention relates to the eyeglasses, however, the present invention can be applied to a display, a monitor and the like worn on a head portion, which may be used for a wearable computer.

1. An eyeglasses frame comprising:
a closing block constituted by a first rim and a second rim;
a hole taper portion expanded and opened to a side of said first rim not facing to said second rim; and
a taper nut having a taper portion in which an outer surface is formed in a circular truncated cone shape, a female screw formed on a center axis of said taper portion and a collar portion formed in an expanded side end portion of said taper portion so as to protrude to said taper portion,
wherein said first rim and said second rim are connected by fitting and attaching the taper nut to the hole taper portion so that a leading end portion corresponding to a reduced side end portion of said taper portion is locked at a position at which the leading end portion is not in contact with said second rim, inserting a male screw inserted to a through hole provided in said second rim to said female screw and fastening the male screw.

2. An eyeglasses frame comprising:
a closing block constituted by a first rim and a second rim;
a hole taper portion provided in said first rim and having a circular truncated cone cross sectional shape in a direction of a center axis;
a taper nut having a taper portion formed in a circular truncated cone side elevational shape, a female screw formed on a center axis of said taper portion and a collar portion formed in an expanded side end portion of said taper portion so as to protrude to said taper portion,
wherein said first rim and said second rim are connected by fitting and attaching the taper nut to the hole taper portion so that a surface of said collar portion sinks under a surface of said first rim, inserting a male screw inserted to a through hole provided in said second rim to said female screw and fastening the male screw so that a screw head of said male screw sinks under the surface of said first rim.

3. An eyeglasses frame comprising:
a closing block constituted by a first rim and a second rim;
a hole taper portion provided at least in said first rim in a state in which the first rim and the second rim are faced to each other, and having a circular truncated cone cross sectional shape in a direction of a center axis;
a taper nut having a taper portion formed in a circular truncated cone shape on an outer peripheral surface, a female screw formed in a center portion of said taper portion and a collar portion formed in an expanded side end portion of said taper portion so as to protrude to said taper portion,
wherein said first rim and said second rim are connected by fitting and attaching the taper nut to the hole taper portion so that the taper nut passes through said first rim from a side to which said hole taper portion is expanded and opened and reaches halfway said second rim, inserting a male screw inserted to a through hole provided in said second rim to said female screw and fastening the male screw so that a screw head of said male screw is brought into contact with a leading end of said taper nut.

4. An eyeglasses frame as claimed in any one of claims 1 to 3, wherein the through hole provided in said second rim is a straight hole.

5. An eyeglasses frame as claimed in claim 3, wherein a part of the through hole provided in said second rim has another hole taper portion which is expanded and opened to a side of a surface of said second rim brought into contact with said first rim, and is continuously formed in said hole taper portion provided in said first rim.

6. An eyeglasses frame as claimed in any one of claims 1 to 3, wherein a hole step portion in which at least a part of said collar portion is received is provided in an expanded side dead end of said hole taper portion, in said first rim.

7. An eyeglasses frame as claimed in any one of claims 1 to 3, wherein said male screw is screwed with said female screw from a side of said leading end portion of said taper nut.

8. An eyeglasses frame having a connecting structure between an end piece and a skull temple for connecting both the parts by gripping a part of the skull temple between branched end piece portions, and inserting a screw to said branched end piece portions and a part of said skull temple gripped between the branched end piece portions, comprising:
an expanded and opened hole taper portion formed at least one of the branched end piece portions;
a taper nut having a female screw formed on a center axis of said taper portion and a collar portion formed in an expanded side end portion of said taper portion so as to protrude to said taper portion;
wherein said end piece and said skull temple are connected by fitting and attaching the taper nut to the hole taper portion so that a leading end portion corresponding to a reduced side end portion of said taper portion passes through a first through hole provided in a part of said skull temple gripped between said branched end piece portions, inserting a male screw to a second through hole provided in another end piece to the end piece portion to which said taper nut is fitted and attached and screwing with said female screw.

9. An eyeglasses frame as claimed in claim 8, wherein a leading end portion of a screw head in said male screw is screwed so as to be in contact with said leading end portion of said taper nut.

10. An eyeglasses frame as claimed in claim 8, wherein no taper is formed in said first through hole, and said skull temple is slidably with respect to said taper nut.

11. An eyeglasses frame as claimed in claim 8, wherein a taper is formed in a part of said second through hole, and said leading end portion of said taper nut is fitted and attached to said second through hole.

12. An eyeglasses frame as claimed in any one of claims 1 to 11, wherein said taper nut is formed by using a more rigid material than that of said rim or said end piece.

13. An eyeglasses frame as claimed in any one of claims 1 to 12, wherein an outer diameter of said male screw is 1.4 mm, the taper portion of said taper nut and said hole taper portion have an equal taper value, and the taper value is equal to or more than 1/30 and equal to or less than 1/15.

14. An eyeglasses comprising:
a hole taper portion formed so as to be expanded and opened to a surface of an eyeglasses lens in a side facing to a human face, and formed in a circular truncated cone cross sectional shape in a direction of a center axis; and
a taper nut having a taper portion having a circular truncated cone shape on an outer peripheral surface, a female screw formed on a center axis of said taper portion, and a collar portion formed in an expanded side end portion of said taper portion so as to protrude to said taper portion,
wherein the taper nut is fitted and attached to the hole taper portion, and said eyeglasses lens and a rim, or said eyeglasses lens and a bridge are connected by screwing a male screw passing through a through hole formed in said rim or said bridge with said female screw.

15. An eyeglasses as claimed in claim 14, wherein said hole taper portion is provided with a hole step portion in which at least a part of said collar portion is received, so as to be connected to an expanded side dead end of said hole taper portion, and said taper nut is fitted and attached to said eyeglasses lens so that a surface of said collar portion does not protrude from a surface of said eyeglasses lens in a side facing to a human face.

16. An eyeglasses as claimed in claim 14, wherein a leading end portion corresponding to a reduced side end portion of said taper portion is fitted and attached so as to be locked at a position at which the leading end portion is not in contact with said rim or said bridge, and said through hole is a straight hole.

17. An eyeglasses comprising:
a hole taper portion formed so as to be expanded and opened to a surface of an eyeglasses lens in a side not facing to a human face, and formed in a circular truncated cone cross sectional shape in a direction of a center axis; and
a taper nut having a taper portion having a circular truncated cone shape on an outer peripheral surface, a female screw formed on a center axis of said taper portion, and a collar portion formed in an expanded side end portion of said taper portion so as to protrude to said taper portion,
wherein the taper nut is fitted and attached to the hole taper portion, and said eyeglasses lens and a rim, or said eyeglasses lens and a bridge are connected by screwing a male screw passing through a through hole formed in said rim or said bridge with said female screw.

18. An eyeglasses as claimed in any one of claims 14 to 17, wherein said taper nut is formed by using a more rigid material than that of said eyeglasses lens.

19. An eyeglasses frame as claimed in any one of claims 14 to 18, wherein an outer diameter of said male screw is 1.4 mm, the taper portion of said taper nut and said hole taper portion have an equal taper value, and the taper value is equal to or more than 1/30 and equal to or less than 1/15.

20. A method of manufacturing an eyeglasses frame in which it is necessary to connect a plurality of frame parts, comprising:
a step of preparing a taper nut having a taper portion in which an outer surface is formed in a circular truncated cone shape, a female screw formed on a center axis of said taper portion and a collar portion formed in an expanded side end portion of said taper portion so as to protrude to said taper portion;
a step of preparing a first frame part having a hole taper portion in which a cross sectional shape in a direction of a center axis is formed in a circular truncated cone shape;
a step of preparing a second frame part having a through hole;
a step of fitting and attaching said taper nut to said hole taper portion of said first frame part;
a step of passing a male screw through said through hole of said second frame part;
a step of facing said first frame part to said second frame part so that a center axis of said hole taper portion coincides with a center axis of said through hole; and
a step of screwing said male screw with said female screw and fastening said male screw.

21. A method of manufacturing an eyeglasses frame as claimed in claim 20, wherein said taper nut is fitted and attached to said first frame part so that a leading end portion corresponding to a reduced side end portion of said taper portion is locked at a position at which the leading end portion is not in contact with said second frame part.

22. A method of manufacturing an eyeglasses frame as claimed in claim 20, wherein at least a part of said collar portion is received in a hole step portion provided in the expanded side dead end of said hole taper portion, thereby fitting and attaching so that a surface of said collar portion does not protrude from a surface of said first frame part, screwing with said taper nut so that a screw head of said male screw does not protrude from a surface of said second frame part, and fastening.

23. A method of manufacturing a rimless eyeglasses in which it is necessary to connect an eyeglasses lens to an end piece or a bridge, comprising:
a step of preparing a taper nut having a taper portion in which an outer surface is formed in a circular truncated cone shape, a female screw formed on a center axis of said taper portion and a collar portion formed in an expanded side end portion of said taper portion so as to protrude to said taper portion;
a step of preparing an eyeglasses lens having a hole taper portion in which a cross sectional shape in a direction of a center axis is formed in a circular truncated cone shape;
a step of preparing said end piece or said bridge in which a through hole is formed;
a step of fitting and attaching said taper nut to said hole taper portion of said eyeglasses lens;
a step of passing a male screw through the through hole formed in said end piece or said bridge;
a step of facing said eyeglasses lens to said end piece or said bridge so that a center axis of said hole taper portion coincides with a center axis of said through hole; and
a step of screwing said male screw with said female screw and fastening said male screw.

24. A method of manufacturing an eyeglasses frame as claimed in claim 23, wherein said taper nut is fitted and attached to said end piece or said bridge so that a leading end portion corresponding to a reduced side end portion of said taper portion is locked at a position at which the leading end portion is not in contact with said end piece or said bridge.

25. A method of manufacturing an eyeglasses frame as claimed in claim 23, wherein at least a part of said collar portion is received in a hole step portion provided in the expanded side dead end of said hole taper portion, thereby fitting and attaching so that a surface of said collar portion does not protrude from a surface of said eyeglasses lens, screwing with said taper nut so that a screw head of said male screw does not protrude from a surface of said end piece or said bridge, and fastening.

26. An eyeglasses frame manufactured in accordance with the method as claimed in claim 20.

27. An eyeglasses manufactured in accordance with the method as claimed in claim 23.

28. An eyeglasses formed by connecting an eyeglasses lens and an eyeglasses frame part, comprising:
a taper nut having a taper portion in which an outer peripheral surface is formed in a circular truncated cone shape, a female screw formed including a center axis of said taper portion, and a collar portion formed in an expanded side end portion of said taper portion so as to protrude to said taper portion;
a first taper hole formed in an opposite surface of the eyeglasses lens to a surface on which eyeglasses parts are mounted so as to be expanded and opened, and having a circular truncated cone cross sectional shape in a direction of a center axis;
a second taper hole having a taper-shaped hole formed in a surface of the eyeglasses frame parts in a side being in contact with the eyeglasses lens so as to be expanded and opened; and
a male screw passing through said second hole taper portion,
wherein the taper nut is fitted and attached to each of the first taper hole and the second taper hole, and said male screw is engaged with a female screw of said taper nut.

29. An eyeglasses as claimed in claim 28, wherein the leading end of said taper nut in the side in which the taper portion is reduced reaches halfway said second taper hole and stay there.

30. An eyeglasses as claimed in claim 28, wherein the leading end of said taper nut in the side in which the taper portion is reduced protrudes from said second taper hole, and a washer is interposed between said eyeglasses frame parts and said male screw.

31. An eyeglasses as claimed in claim 28, wherein the leading end portion of said taper nut in the side in which the taper portion is reduced protrudes from said second taper hole, and said protruding leading end portion is deformed by fastening said male screw.

32. An eyeglasses as claimed in claim 31, wherein an opening portion of said second taper hole in a side to which the leading end of said taper nut protrudes has a chamfer portion, and the leading end portion of said deformed taper nut covers said chamfer portion.

33. An eyeglasses as claimed in claim 31, wherein said male screw has a corner portion forming a camber expanding and opening from a screw portion toward a screw head under the screw head, and said corner portion deforms the leading end portion of said taper nut by fastening said male screw.

34. An eyeglasses formed by facing an eyeglasses lens to an eyeglasses frame part and connecting both the elements, comprising:
a taper nut having a first taper portion in which an outer peripheral surface is formed in a circular truncated cone shape, a female screw formed on a center axis of said first taper portion, and a collar portion formed in an expanded side end portion of said first taper portion so as to protrude to said taper portion;
a first taper-shaped hole formed so as to be expanded and opened to an opposite surface to a side connected to said eyeglasses frame part, having a circular truncated cone cross sectional shape in a direction of a center axis, and formed in said eyeglasses lens;
a male screw having a second taper portion including a taper reduced from a screw head toward a screw portion, between the screw head and the screw portion; and
a second taper-shaped hole formed so as to be expanded and opened to an opposite surface to a side connected to said eyeglasses lens, having a circular truncated cone cross sectional shape in the direction of the center axis, and formed in said eyeglasses frame part,
wherein the taper nut is fitted to the first taper-shaped hole, the male screw is fitted to the second taper-shaped hole, and said female screw and said male screw are engaged.

35. An eyeglasses having an eyeglasses lens and an eyeglasses frame part, comprising:
a first taper nut having a first taper portion in which an outer peripheral surface is formed in a circular truncated cone shape, a first taper hole formed on a center axis of said first taper portion and having a taper-shaped hole reduced in a direction of an expanded side end portion of said first taper portion, and a collar portion formed in an expanded side end portion of said first taper portion so as to protrude to said taper portion;
a second taper hole formed so as to be expanded and opened to a surface in an opposite side to a side connected to said eyeglasses frame part, having a circular truncated cone cross sectional shape in a direction of a center axis, and formed in said eyeglasses lens;
a second taper nut having a second taper portion in which an outer peripheral surface is formed in a circular truncated cone shape, a female screw formed on a center axis of said second taper portion, and a collar portion formed in an expanded side end portion of said second taper portion so as to protrude to said taper portion; and
a third taper hole formed so as to be expanded and opened to a surface in an opposite side to a side connected to said eyeglasses lens, having a circular truncated cone cross sectional shape in a direction of a center axis, and formed in said eyeglasses frame part,
wherein the first taper nut is fitted to the second taper hole, the second taper nut is fitted to the third taper hole, at least a part of said second taper portion is fitted to said first taper hole, and a male screw passing through said second taper hole and said female screw are engaged.

36. An eyeglasses having an eyeglasses lens and an eyeglasses frame part, comprising:
a taper nut having a first taper portion in which an outer peripheral surface is formed in a circular truncated cone shape, a second taper portion having a taper reduced in an opposite direction to a direction in which a taper of said first taper portion is reduced, through holes formed on a center axis of said first taper portion and said second taper portions, and a collar portion formed between said first taper portion and said second taper portion so as to protrude to said first taper portion and said second taper portion;
a first taper-shaped hole formed so as to be expanded and opened to a surface of the eyeglasses lens in a side to which the eyeglasses frame part is mounted, and having a circular truncated cone cross sectional shape in a direction of a center axis; and
a second taper-shaped hole having a taper-shaped hole formed so as to be expanded and opened to a surface of the eyeglasses frame part in a side being in contact with the eyeglasses lens,
wherein said first taper portion of the taper nut is fitted to the first taper-shaped hole, said second taper portion is fitted to the second taper-shaped hole, and a bolt passing through said through hole from a side of said second taper portion is engaged with a nut from a side of said first taper portion.

37. A fastening structure of members comprising:
a first taper nut having a first taper portion in which an outer peripheral surface is formed in a circular truncated cone shape, a collar portion formed in an expanded side end portion of said first taper portion so as to protrude to said taper portion, and a first taper hole formed on a center axis of said first taper portion and having a taper-shaped hole reduced in a direction of said collar portion from a reduced side end portion of said first taper portion;
a second taper hole formed in a first member and having a circular truncated cone cross sectional shape in a direction of a center axis;
a second taper nut having a second taper portion in which an outer peripheral surface is formed in a circular truncated cone shape, a female screw formed on a center axis of said second taper portion, and a collar portion formed in an expanded side end portion of said second taper portion so as to protrude to said taper portion; and
a third taper hole formed so as to be expanded and opened to a second member, and having a circular truncated cone cross sectional shape in a direction of a center axis,
wherein the first taper nut is fitted to the second taper hole, the second taper nut is fitted to the third taper hole, at least a part of said second taper portion is fitted to said first taper hole, and a male screw passing through said second taper hole and said female screw are engaged.

38. A fastening structure of members comprising:
a taper nut having a first taper portion in which an outer peripheral surface is formed in a circular truncated cone shape, a second taper portion having a taper reduced in an opposite direction to a direction in which a taper of said first taper portion is reduced, through holes formed on a center axis of said first taper portion and said second taper portion, and a collar portion formed between said first taper portion and said second taper portion so as to protrude to said first taper portion and said second taper portion;
a first taper-shaped hole formed so as to be expanded and opened to a first member, and having a circular truncated cone cross sectional shape in a direction of a center axis; and
a second taper-shaped hole having a taper-shaped hole formed so as to be expanded and opened to a second member,
wherein said first taper portion of the taper nut is fitted to the first taper-shaped hole, said second taper portion is fitted to the second taper-shaped hole, and a bolt passing through said through hole from a side of said first member is engaged with a nut in a side of said second member.
